(19) United States
(12) Patent Application Publication
(10) Pub. No.: US 2014/0181221 A1
(43) Pub. Date: Jun. 26, 2014

(54) ANALYZING A MESSAGE USING LOCATION-BASED PROCESSING

(71) Applicant: LONGSAND LIMITED, Fort Collins, CO (US)

(72) Inventors: Harsha Raghavendra Kushtagi, Bangalore (IN); Manjunath Bharadwaj Bharadwaj, Bangalore (IN); Saurabh Gupta, Bangalore (IN); Reuti Raman Babu, Bangalore (IN); Neeraj Kumar Chauhan, Bangalore (IN)

(73) Assignee: Longsand Limited, Fort Collins, CO (US)

(21) Appl. No.: 13/723,325

(22) Filed: Dec. 21, 2012

(51) Int. Cl. H04L 12/58

(52) U.S. Cl. CPC H04L 51/12
USPC 709/206

(57) ABSTRACT

Techniques for analyzing a message using location-based processing are described in various implementations. In one example implementation, a method may include receiving a message from a first user to a second user. The method may also include determining location information associated with the message, the location information including a first location associated with the first user, a second location associated with the second user, or both the first location and the second location. The method may also include determining, based on the location information, location-based processing to be applied when analyzing content of the message. The method may also include analyzing the content of the message to determine whether the message contains potentially unintended content using the location-based processing.

### BACKGROUND

Words and phrases often have different meanings in different geographic regions. For example, in Hawaii, the word “slipper” is often used to refer to a certain type of outdoor footwear (e.g., a sandal or a flip-flop), while in much of the rest of the United States, the word “slipper” is often used to refer to a different type of footwear that is primarily worn indoors. Similarly, certain words used in a particular sequence may take on a special meaning to people of a particular region, and the special meaning may and up being very different from the literal meaning of the words themselves.

Due to such regional differences, a written or verbal communication may take on different meanings depending on who is interpreting the language of the communication. For example, a person may write a phrase that means one thing to the writer, but means another thing to the reader. Oftentimes, the result of such different interpretations may lead to confusing or amusing situations that otherwise end up being benign. For example, travelers who are unfamiliar with the intricacies of a foreign language may often say things that sound confusing or amusing to the local population, even if the travelers are using words that literally translate to what they intended to say. However, sometimes the different interpretations may cause unintended offense to one of the parties to the communication, such as when a normal, harmless word or phrase in one region is considered insulting, derogatory, or otherwise offensive in another region.

### BRIEF DESCRIPTION OF THE DRAWINGS

FIG. 1 shows a conceptual diagram of an example messaging environment in accordance with implementations described herein.

FIG. 2 shows a flow diagram of an example process for analyzing content of a message using location-based processing in accordance with implementations described herein.

FIG. 3 shows a block diagram of an example system in accordance with implementations described herein.

### DETAILED DESCRIPTION

Today, people from almost anywhere in the world can communicate with people from other parts of the world using a number of different communications channels. Such communications may occur in real-time (e.g., by telephone, voice-over-IP, video conferencing, and the like) or via a messaging system (e.g., email, text messaging, voicemail, video messaging, posts to social or business networking sites. Internet message boards, and the like). Although real-time communications by their very nature do not readily lend themselves to pre-filtering and/or analysis of the content that is being communicated, messaging system communications may be analyzed or otherwise filtered between the time that a message is generated by the sender and when it is received by the recipient.

Some messaging systems may be configured to screen messages for inappropriate content or subject matter. For example, in a corporate environment, a compliance administrator may set up rules for blocking communications that might run afoul of the company's policies, laws by which corporate communications are governed, or both. Messaging systems may also be configured to screen messages for other reasons.

In some cases, such screening may take the form of basic keyword matching, so that if a particular message contains a particular keyword, then the message may be flagged as containing inappropriate content or subject matter. In other cases, the screening may include more intelligent content analysis techniques, e.g., to understand the meaning of a particular word or phrase in the specific context in which it is used in the message. However, neither of these techniques considers the location of the sender and/or the receiver when analyzing the content of the message.

In accordance with the techniques described here, a messaging system may apply intelligent, location-based message content analysis to determine whether a message includes potentially unintended or inappropriate content. If so, the messaging system may take appropriate action, e.g., by notifying the sender of the potentially unintended or inappropriate content, by notifying a compliance administrator of the message, and/or by blocking the message from being delivered to the recipient.

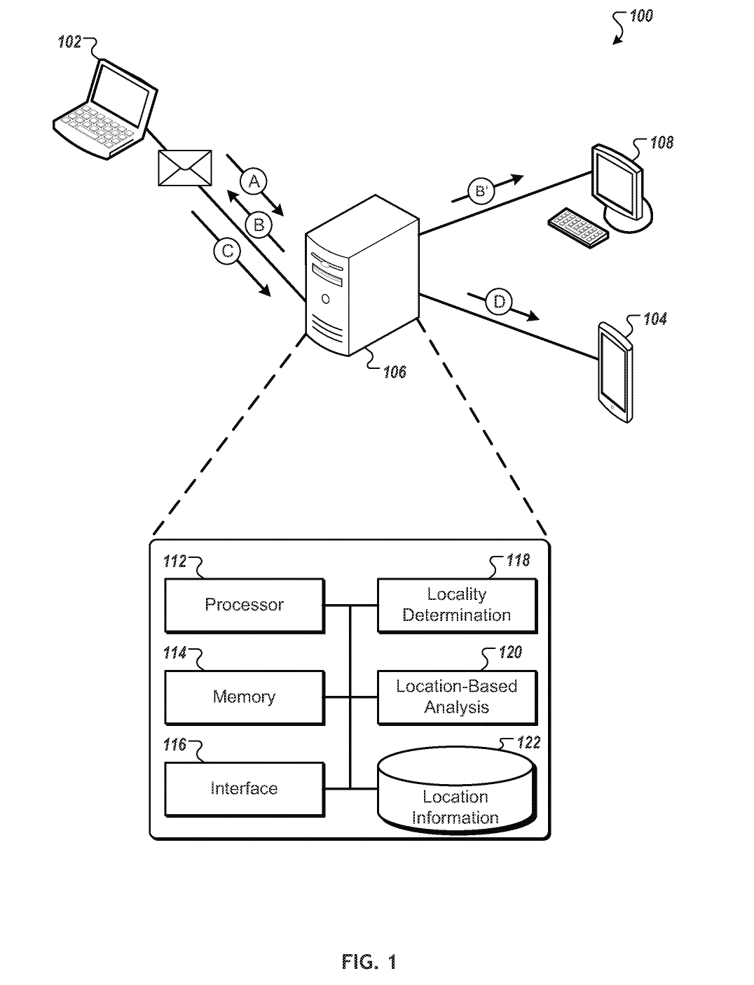

FIG. 1 shows a conceptual diagram of an example messaging environment 100 in accordance with implementations described herein. As shown, the messaging environment 100 includes a sender computing device 102, a recipient computing device 104, and a messaging system 106 that facilitates delivery of messages from the sender computing device 102 to the recipient computing device 104. In some implementations, environment 100 may also include an administrator computing device 108.

The example topology of environment 100 may provide messaging capabilities representative of various messaging environments, and the various systems and computing devices in environment 100 may be interconnected through one or more communications networks. However, it should be understood that the example topology of environment 100 is shown for illustrative purposes only, and that various modifications may be made to the configuration. For example, messaging environment 100 may include different or additional components, or the components may be connected in a different manner than is shown. Additionally, while devices 102, 104, and 108 are illustrated as a laptop computing device, a srnartphone computing device, and a desktop computing device, respectively, it should be understood that any of the devices may, in practice, be any appropriate type of computing device, including for example smartphones, tablets, desktops, laptops, workstations, servers, or the like. Similarly, system 106 may be any appropriate type of single computing device or group of computing devices operating together as a system.

In environment 100, the content of various forms of messages (e.g., emails, text messages, voice messages, and the like) may be analyzed between the time that the message is generated (e.g., by a sender) and when the message is delivered (e.g., to a recipient). The messages may be analyzed using location-based processing that allows messaging system 106 to understand what the sender likely intended by the message, how the recipient is likely to interpret the message, or both, based on the geographic locations associated with the sender and/or the receiver.

An example message flow in environment 100 is shown by the arrows labeled A, B, B′, C, and D. For example, a first user (e.g., a sender) may compose an original message using sender computing device 102, e.g., by typing an email into an email client operating on the device, or by speaking a message that is transcribed into a text message by the device, or using other message generation mechanisms. The user may address the message using known techniques, e.g., by entering one or more email addresses, phone numbers, or the like, into a recipient field. When the user has finished composing the message, the user may initiate a sending mechanism, e.g., by clicking a “send” button. In response, the message may be sent to the messaging system 106, as shown by the arrow labeled A.

The messaging system 106 may receive the message, and may analyze the message to determine whether the message contains inappropriate or potentially unintended content. For example, the messaging system 106 may analyze the content, context, and/or tone of the message to determine whether the message might be construed as offensive, harassing, or discriminatory by the recipient of the message. Such analysis may utilize location-based processing that is tailored to the location of the sender, the location of the recipient, or both. For example, if the recipient is located in Hawaii, and the sender is located in New York, then the term “slipper” that is included in the content of the message may be interpreted differently than if the users were located in different geographical regions.

The location-based processing may include configurable rules that allow the messaging system 106 to understand the meaning of the message being delivered, and how the message would likely be interpreted by the sender and the recipient, based on their respective locations. For example, the configurable rules may describe social norm information for a particular location that includes any non-literal translations of words or terms as they are likely to be interpreted in that particular location. If the likely intended meaning from the sender perspective matches the likely interpreted meaning from the recipient perspective, than the message may be delivered as composed. If the likely intended meaning from the sender perspective does not match the likely interpreted meaning from the recipient perspective, then the message may not be delivered to the intended recipient.

In the case that the message contains potentially unintended content, the messaging system 106 may notify the sender (e.g., as shown by the arrow labeled B) that the message as originally composed contains potentially unintended content. For example, the system may return the original message back to the sender and/or deliver a notification to be presented to the sender on the sender computing device 102. The notification may prompt the sender to review the content of the message, and to either edit the message or to confirm that the content of the message was intended by the sender.

In some implementations, the notification may indicate the portion of the message that is associated with the potentially unintended content. For example, the messaging system 106 may mark up the original message by highlighting the portion of the message associated with the potentially unintended content. In some implementations, the notification may also include a suggested modification to the portion of the message associated with the potentially unintended content. For example, continuing with the “slipper” example, the notification may highlight the term “slipper” and suggest that the sender change the word to “sandal” or “flip-flop”.

After receiving notification that the message contains potentially unintended content, and was therefore not delivered to the intended recipient, the sender may be provided one or more choices to confirm that the message should be delivered. For example, in some cases, the sender may be allowed to ignore or override the notification from messaging system 106, by affirmatively indicating that the original message was what the sender intended. The sender may also be allowed to correct the content of the message, and resend the message as indicated by the arrow labeled C. In either case, the messaging system 106 may then deliver the message, either as originally composed or as modified, to the recipient computing device 104.

In some implementations, if the messaging system 106 determines that the message contains potentially unintended content that is likely to be offensive, harassing, or discriminatory to the intended recipient, the system may irrevocably block the message from being delivered to the recipient. For example, even in cases where a sender is generally allowed to override the notification from the messaging system 106, such an irrevocably blocked message would not be delivered. In addition, messaging system 106 may initiate a reporting mechanism to notify a compliance administrator of any message that is determined to include such offensive, harassing, or discriminatory content. For example, the messaging system 106 may forward such messages to administrator computing device 108 as shown by the arrow labeled B′, and may also block the message from being delivered to recipient computing device 104.

It should be understood that the example message flow described above is for illustrative purposes only, and that other message flows and policies may also be used with the present techniques.

Messaging system 106 may include a processor 112, a memory 114, an interface 116, a locality determination module 118, a location-based analysis engine 120, and a location information repository 122. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown. In some implementations, portions or all of functionality described as part of messaging system 106 may be implemented on the sender computing device 102 and/or the recipient computing device 104. For example, portions or all of the functionality may be integrated with or implemented by a messaging client application, such as an email client, a text client, or the like.

Processor 112 may be configured to process instructions for execution by the messaging system 106. The instructions may be stored on a non-transitory, tangible computer-readable storage medium, such as in memory 114 or on a separate storage device (not shown), or on any other type of volatile or non-volatile memory that stores instructions to cause a programmable processor to perform the techniques described herein. Alternatively or additionaily, messaging system 106 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 116 may be implemented in hardware and/or software, and may be configured, for example, to receive and respond to messages received from one or more senders. For example, interface 116 may be configured to receive messages from one or more senders that are intended for one or more recipients, and to respond to the one or more senders, e.g., by returning the message for modification, or by sending a notification to the user that the message contains potentially unintended content, or by taking other appropriate action. Interface 116 may also include one or more user interfaces that allow a user to interact with the messaging system 106. Example user interfaces may include touchscreen devices, pointing devices, keyboards, voice input interfaces, visual input interfaces, or the like.

The locality determination module 118 may execute on one or more processors, and may determine location information associated with a message. For example, the locality determination module 118 may determine a location associated with the sender of the message, a location associated with the intended recipient of the message, or both. In some cases, the location of a user may be directly ascertainable, such as by querying an address book of known users, or by obtaining the user's location from global positioning system (GPS) data, or using other available techniques. For example, the location associated with a sender may be determined from a user profile or other information associated with the user, and the location associated with the intended recipient may be obtained using the lightweight directory access protocol (LDAP) or based on location information associated with previous communications sent from the recipient to the sender. Other appropriate location determination techniques may also be used.

In some cases, a user may have a number of different associated locations, such as a home location, a work location, a current location, and the like. In such cases, the locality determination module 118 may perform a hierarchical analysis of the user's associated locations, depending on the relevancy of the location to the message content analysis. For example, a user's home location may be the most relevant in terms of determining how the user is likely to interpret a particular word or phrase, and as such, if the home location is available, the locality determination module 118 may return the home location. If the home location is not available, then a next most relevant location may be determined and returned, and so on. The hierarchy of locations may be configurable, and may be defined on an implementation-specific basis.

In some implementations, when an actual locality of a user is unknown or is ambiguous, the locality determination module 118 may infer a probable locality of the user based on information that may be considered indicative of (but not necessarily dispositive of) the user's location. For example, the user may not have a known address, but may have a known telephone number with an area code that may approximate the area where the user is likely located. The area code may be indicative of the user's location within a particular geographic region, but may not be dispositive due to VoIP and other telephone systems that allow a user to have a telephone number associated with a different geographic region than the user. As another example, the user's Internet protocol address may be used to approximate the user's location, but again, the address may not be dispositive. As another example, the time zone settings on a user's device may be used to infer broad location information about the user. These and/or other techniques, alone or in combination, may be used by the locality determination module 118 to provide a best guess at the sender's and/or the recipient's location. Various rules and data for performing such locality determinations may be stored in the location information repository 122.

The location-based analysis engine 120 may execute on one or more processors, and may analyze the content and context of received messages to determine whether the messages contain potentially unintended content. Such analysis may be location-specific to account for different language interpretations in different geographical regions. For example, the location-based analysis engine 120 may analyze the content from the perspective of a user in the sender's location to determine what the sender intended by the content of the message, or may analyze the content from the perspective of a user in the recipient's location to determine how the recipient is likely to interpret the content of the message, or both. In some implementations, the location-based analysis engine 120 may also analyze the content of an attachment to the message using location-based processing to determine whether the attachment contains potentially unintended content.

The location-based analysis engine 120 may utilize any appropriate content and context analysis techniques, depending on the particular implementation. For example, the location-based analysis engine 120 may utilize keyword and or phrase-matching analysis, semantic inference analyses, Bayesian analyses, meaning-based analyses, or other appropriate techniques or combinations of techniques. Regardless of the type of analysis being performed, at least a portion of the analysis is location-based, such that the location information associated with a particular message will affect how the message is interpreted by location-based analysis engine 120. Various rules and taxonomies for performing such location-based analysis may be stored in the location information repository 122.

In response to determining that the location-based content analysis reveals potentially unintended content, the analysis engine 120 may be configured to perform one or more appropriate actions. The appropriate actions may be implementation-specific, and may be described in a configurable policy that may allow an administrator (e.g., a compliance administrator) to define the appropriate actions for a particular scenario.

In some implementations, when the analysis engine 120 determines that the message contains potentially unintended content, the engine may identify the portion of the message that is associated with the potentially unintended content. The analysis engine 120 may also generate a suggested modification to that portion of the message. In some implementations, when the analysis engine 120 determines that the message contains potentially unintended content that is also likely to be offensive, harassing, or discriminatory to the recipient, the engine may initiate a reporting mechanism to notify a compliance administrator of the message.

In some implementations, messaging system 106 may also include a transcription module (not shown) to convert different message types to text to be analyzed by the location-based analysis engine 120. For example, in the case of a voicemail or other audio input, the transcription module may transcribe the voicemail or other audio into text. As another example, in the case of a video input, the audio portion of the video may be transcribed into text. However, it should be understood that location-based analysis engine 120 may also be configured to analyze content of any appropriate type, including text, audio, video, image, or other content.

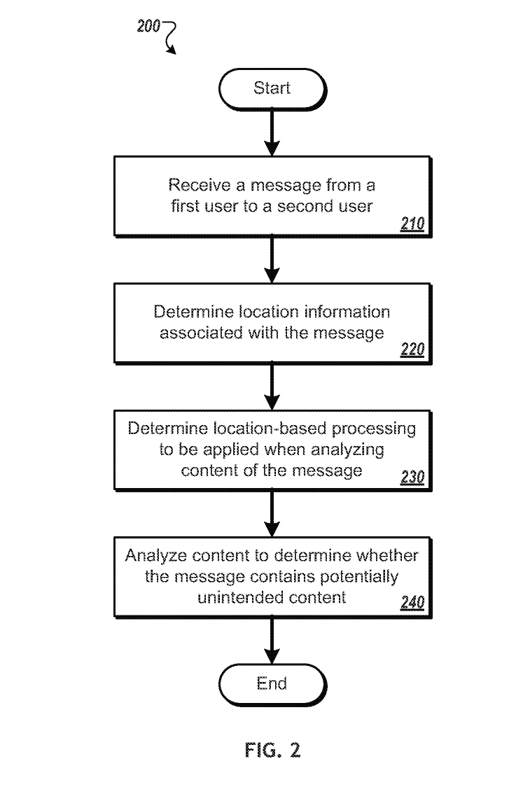

FIG. 2 shows a flow diagram of an example process for analyzing content of a message using location-based processing in accordance with implementations described herein. The process 200 may be performed, for example, by a messaging system such as the messaging system 106 illustrated in FIG. 1. Process 200 may also be performed by an integrated messaging system, e.g., as a module that is integrated with a messaging client operating on sender computing device 102, for example. It should be understood that another system, or combination of systems, may be used to perform the process or various portions of the process.

Process 200 begins when a message from a first user to a second user is received at block 210. For example, in the case of a remote messaging system 106, a composed message may be sent from the user computing device and received by the messaging system 106. In the case of an integrated messaging system, receiving the message may occur as the user is entering the message, or after the user has completed composing the message or a portion of the message. At block 220, location information associated with the message is determined. The location information may include a first location associated with the first user, a second location associated with the second user, or both. The location information may be obtained by the messaging system 106, or by a separate locality determination module operating separately from the messaging system 106.

At block 230, location-based processing to be applied when analyzing the content of the message is determined based on the location information. In some cases, the location-based processing to be applied may include comparing the content of the message to social norm information associated with the first location, the second location, or both the first and the second location.

At block 240, the content of the message is analyzed using the location-based processing to determine whether the message contains potentially unintended content. If so, then the first user may be notified that the message contains potentially unintended content before the message is delivered to the second user, and the first user may be provided an opportunity to modify the message before it is delivered. In some cases, notifying the first user includes indicating a portion of the message that is associated with the potentially unintended content, and may also include providing a suggested modification to that particular portion of the message.

In some implementations, if the potentially unintended content is likely to be offensive, harassing, or discriminatory to the second user, the message may be blocked from being delivered to the second user. In such cases, a reporting mechanism may also be initiated to notify a compliance administrator of the message. For example, the messaging system 106 may forward the message to a compliance administrator, or may generate a report summarizing the offending message, or the like.

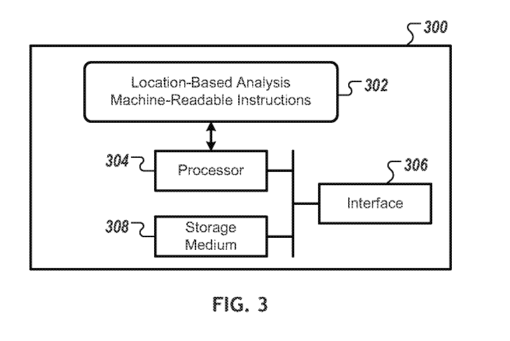

FIG. 3 shows a block diagram of an example system 300 in accordance with implementations described herein. The system 300 includes location-based analysis machine-readable instructions 302, which may include certain of the various modules of the computing devices depicted in FIG. 1. The resource selection machine-readable instructions 302 are loaded for execution on a processor or processors 304. A processor can include a microprocessor, microcontroller, processor module or subsystem, programmable integrated circuit, programmable gate array, or another control or computing device. The processor(s) 304 can be coupled to a network interface 306 (to allow the system 300 to perform communications over a data network) and a storage medium (or storage media) 308.

The storage medium 308 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other appropriate types of storage devices. Note that the instructions discussed above can be provided on one computer-readable or machine-readable storage medium, or alternatively, can be provided on multiple computer-readable or machine-readable storage media distributed in a system having possibly plural nodes. Such computer-readable or machine-readable storage medium or media is (are) considered to be part of an article (or article of manufacture). An article or article of manufacture can refer to any appropriate manufactured component or multiple components. The storage medium or media can be located either in the machine running the machine-readable instructions, or located at a remote site, e.g., from which the machine-readable instructions can be downloaded over a network for execution.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method comprising:
receiving, at a computing system, a message from a first user to a second user;
determining, using the computing system, location information associated with the message, the location information including a first location associated with the first user, a second location associated with the second user, or both the first location and the second location;
determining, using the computing system and based on the location information, location-based processing to be applied when analyzing content of the message; and
analyzing, using the computing system, the content of the message to determine whether the message contains potentially unintended content using the location-based processing.

2. The method of claim 1, further comprising, in response to determining that the message contains potentially unintended content, notifying the first user that the message contains potentially unintended content before delivering the message to the second user.

3. The method of claim 2, wherein notifying the first user includes indicating a portion of the message that is associated with the potentially unintended content.

4. The method of claim 3, wherein notifying the first user further includes providing a suggested modification to the portion of the message that is associated with the potentially unintended content.

5. The method of claim 1, wherein the location-based processing includes comparing the content of the message to social norm information associated with the first location, the second location, or both the first location and the second location.

6. The method of claim 1, further comprising, in response to determining that the message contains potentially unintended content that is likely to be offensive, harassing, or discriminatory to the second user, blocking the message from being delivered to the second user.

7. The method of claim 6, further comprising, in response to determining that the message contains potentially unintended content that is likely to be offensive, harassing, or discriminatory to the second user, initiating a reporting mechanism to notify a compliance administrator of the message.

8. The method of claim 1, further comprising analyzing an attachment to the message to determine whether the attachment contains potentially unintended content using the location-based processing.

9. A system comprising:
one or more processors;
an interface, executing on at least one of the one or more processors, to receive a message from a sender to a recipient;
a locality module, executing on at least one of the one or more processors, to determine a recipient location associated with the recipient; and
an analysis engine, executing on at least one of the one or more processors, to analyze content of the message to determine whether the message contains potentially unintended content based on social norms associated with the recipient location.

10. The system of claim 9, wherein the analysis engine, in response to determining that the message contains potentially unintended content, identifies a portion of the message that is associated with the potentially unintended content.

11. The system of claim 10, wherein the analysis engine, in response to determining that the message contains potentially unintended content, generates a suggested modification to the portion of the message that is associated with the potentially unintended content.

12. The system of claim 10, wherein the analysis engine, in response to determining that the message contains potentially unintended content that is likely to be offensive, harassing, or discriminatory to the recipient, causes the message to be blocked from delivery to the recipient.

13. The system of claim 12, wherein the analysis engine, in response to determining that the message contains potentially unintended content that is likely to be offensive, harassing, or discriminatory to the recipient, initiates a reporting mechanism to notify a compliance administrator of the message.

14. The system of claim 9, wherein the locality module determines the recipient location based on location information associated with previous communications sent from the recipient to the sender.

15. A non-transitory computer-readable storage medium storing instructions that, when executed by one or more processors, cause the one or more processors to:
determine location information associated with a message from a sender to a recipient, the location information including a first location associated with the sender, a second location associated with the recipient, or both the first location and the second location;
determine, based on the location information, location-based processing to be applied when analyzing content of the message; and
analyze the content of the message to determine whether the message contains potentially unintended content using the location-based processing.
